(19) United States
(12) Patent Application Publication
(10) Pub. No.: US 2011/0243743 A1
(43) Pub. Date: Oct. 6, 2011

(54) ATTACHMENT ASSEMBLIES BETWEEN TURBINE ROTOR DISCS AND METHODS OF ATTACHING TURBINE ROTOR DISCS

(75) Inventors: Ian David Wilson, Simpsonville, SC (US); Christopher Sean Bowes, Simpsonville, SC (US)

(73) Assignee: General Electric Company

(21) Appl. No.: 12/754,963

(22) Filed: Apr. 6, 2010

(51) Int. Cl. F01D 5/22; B23P 11/00

(52) U.S. Cl. 416/194; 29/889.21

(57) ABSTRACT

A method of attaching two rotor discs in a turbine engine, the method comprising the steps of: forming a first rotor disc that includes a first axial extension and a disc flange; forming a second rotor disc that includes a second axial extension and a weld surface; forming a bridge, the bridge that includes a bridge flange at one end and a weld surface at the other end, and, along an outer radial surface, the bridge comprises means for sealing; attaching the bridge to the second rotor disc via welding the weld surfaces of the bridge and the second axial extension; and attaching the first rotor disc to the bridge via removably securing the disc flange to the bridge flange.

### BACKGROUND OF THE INVENTION

This present application relates to rotor discs within turbine engines, which, as used herein and unless specifically stated otherwise, is meant to include all types of turbine or rotary engines, including combustion turbine engines, aircraft engines, power generating combustion engines, steam turbines and others. More specifically, but not by way of limitation, the present application relates to improved assemblies for attaching turbine rotor discs and methods of attaching turbine rotor discs, as well as providing seal structures between turbine rotor discs.

It will be appreciated that many solutions have been proposed in regard to the structural connections, sealing assemblies, and other structure that generally resides between and connects neighboring rotor discs to each other in turbine engines, as these components are configured to address several operational requirements. For example, a torque arm is often used to as a structural feature that transmits torque between the neighboring turbine discs. Separate from the torque arm, a seal arm generally is used in conjunction with the torque arm. The seal arm is generally positioned in an outboard positioned and configured to form a seal between itself and surrounding stationary structure. Other conventional designs provide a separate spacer wheel, which is capable of carrying torque loads and that has seal teeth, positioned between the neighboring rotor discs.

In some instances, the torque transmission structure is fashioned between the rotor discs by welding integrally formed arms that extend from each of the discs. However, forming integral arms of the length needed to make this connection drastically increases the forging cost associated with manufacturing the rotor discs. One solution that skirted this problem proposed a series of welds that created a torque arm that spanned the distance without needing lengthy integrally formed extensions from the rotor discs. However, when adjacent rotors disc are welded together in this fashion, there are often issues of distortion causing poor concentricity between the two rotor structures. This resultant eccentricity can lead to unbalance problems. In addition, welding often creates metallurgical defects and stress concentrations that need to be addressed after the welding process is complete. Ideally the weld drop should be machined smooth to alleviate these concerns. However, it will be appreciated that a fully welded torque arm of this nature would block access to the inner surfaces of the welded structure once the welding of the torque arm is complete, which would make it impossible to machine the underside of the weld.

In some conventional structures, the torque arms are configured with multiple bolted connections. However, multiple bolted connections are undesirable because of the axial length they require, high cost, and the additional weight they bring to the assembly.

As such, there is need for a torque arm that avoids the shortcomings of conventional assemblies. Particularly, there is a need for a torque arm that satisfies the required structural and sealing functions found in this are of the turbine engine while also being cost-effective to manufacture and efficient in assembly.

### BRIEF DESCRIPTION OF THE INVENTION

The present application thus describes a method of attaching two rotor discs in a turbine engine, the method comprising the steps of: forming a first rotor disc that includes a first axial extension extending from a web portion of the first rotor disc, wherein, at a distal end, the first axial extension comprises a disc flange; forming a second rotor disc that includes a second axial extension extending from a web portion of the second rotor disc, wherein, at a distal end, the second axial extension comprise a weld surface; forming a bridge, the bridge that includes a bridge flange at one end and a weld surface at the other end, and, along an outer radial surface, the bridge comprises means for sealing; attaching the bridge to the second rotor disc via welding the weld surface of the bridge to the weld surface of the second axial extension; and attaching the first rotor disc to the bridge via removably securing the disc flange to the bridge flange.

The present application further describes a method of attaching two rotor discs in a turbine engine that includes the steps of: forming a first rotor disc that includes a first axial extension extending from a web portion of the first rotor disc, wherein, at a distal end, the first axial extension comprises a disc flange; forming a second rotor disc that includes a second axial extension extending from a web portion of the second rotor disc, wherein, at a distal end, the second axial extension comprise a weld surface; forming a bridge, the bridge that includes a bridge flange at one end and a weld surface at the other end, and, along an outer radial surface, the bridge comprises means for sealing; attaching the bridge to the second rotor disc via welding the weld surface of the bridge to the weld surface of the second axial extension; while at least one of the first rotor disc and the second disc comprises an uninstalled condition, machining an underside of the weld formed between the weld surface of the bridge to the weld surface of the second axial extension from an inner radial position; and after machining the weld formed between the weld surface of the bridge and the weld surface of the second axial extension; attaching the first rotor disc to the bridge via removably securing the disc flange to the bridge flange.

The present application further describes an assembly of rotor discs in a turbine engine that includes: a first rotor disc and a second rotor disc that are spaced and positioned to rotate about a common axis; and a torque arm that comprises an attachment distance defined by a predetermined radial location along a web portion of the first rotor disc and a predetermined radial location along a web portion of the second rotor disc; the torque arm structurally connecting the first rotor disc and the second rotor disc between the predetermined radial locations along each web portion and arm extending circumferentially to form a cylinder shape that substantially separates the hot gas path of the turbine engine from a rotor disc cavity formed on an inboard side of the torque arm. The torque arm may include three connected structural sections: i) a first axial extension that extends from the first rotor disc, is integrally formed therewith, and, at a distal end, comprises a disc flange; ii) a second axial extension that extends from the second rotor disc, is integrally formed therewith, and, at a distal end, comprises a weld surface; and iii) a bridge that, at one end, includes a bridge flange configured to form a mechanical connection with the disc flange and, at the other end, a weld surface configured to form a weld connection with the weld surface of the second axial extension; securing means removably join the disc flange to the bridge flange. Along an outboard surface, the torque arm may include means for forming a seal between the torque arm and stationary structure that, upon installation within the assembled turbine engine, surrounds the torque arm from an outboard position. The first axial extension and the second axial extension each may have a length that is less than 0.4 of the attachment distance.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic representation of an exemplary turbine engine in which certain embodiments of the present application may be used;

FIG. 2 is a sectional view of the compressor section of the combustion turbine engine of FIG. 1;

FIG. 3 is a sectional view of the turbine section of the combustion turbine engine of FIG. 1;

FIG. 4 is a section view of a schematic representation of a rotor disc attachment assembly according to an exemplary embodiment of the present application;

FIG. 5 is a section view of a schematic representation of a rotor disc attachment assembly according to an alternative embodiment of the present application; and

FIG. 6 is a section view of a schematic representation of a rotor disc attachment assembly according to an alternative embodiment of the present application.

### DETAILED DESCRIPTION OF THE INVENTION

As an initial matter, to communicate clearly the invention of the current application, it may be necessary to select terminology that refers to and describes certain parts or machine components of a turbine engine and related systems. Whenever possible, industry terminology will be used and employed in a manner consistent with its accepted meaning. However, it is meant that any such terminology be given a broad meaning and not narrowly construed such that the meaning intended herein and the scope of the appended claims is unreasonably restricted. Those of ordinary skill in the art will appreciate that often a particular component may be referred to using several different terms. In addition, what may be described herein as a single part may include and be referenced in another context as consisting of several component parts, or, what may be described herein as including multiple component parts may be fashioned into and, in some cases, referred to as a single part. As such, in understanding the scope of the invention described herein, attention should not only be paid to the terminology and description provided, but also to the structure, configuration, function, and/or usage of the component, as provided herein.

In addition, several descriptive terms may be used regularly herein, and it may be helpful to define these terms at this point. These terms and their definition given their usage herein is as follows. The term “rotor blade”, without further specificity, is a reference to the rotating blades of either the compressor or the turbine, which include both compressor rotor blades and turbine rotor blades. The term “stator blade”, without further specificity, is a reference the stationary blades of either the compressor or the turbine, which include both compressor stator blades and turbine stator blades. The term “blades” will be used herein to refer to either type of blade. Thus, without further specificity, the term “blades” is inclusive to all type of turbine engine blades, including compressor rotor blades, compressor stator blades, turbine rotor blades, and turbine stator blades. Further, as used herein, “downstream” and “upstream”, as well as “forward” and “aft”, are terms that indicate a direction relative to the flow of working fluid through the turbine. As such, the term “downstream” refers to a direction that generally corresponds to the direction of the flow of working fluid, and the term “upstream” or “forward” generally refers to the direction that is opposite of the direction of flow of working fluid. The terms “trailing” or “aft” and “leading” or “forward” generally refer to relative position in relation to the flow of working fluid. At times, which will be clear given the description, the terms “trailing” and “leading” may refer to the direction of rotation for rotating parts. When this is the case, the “leading edge” of a rotating part is the front or forward edge given the direction that the part is rotating and, the “trailing edge” of a rotating part is the aft or rearward edge given the direction that the part is rotating.

The term “radial” refers to movement or position perpendicular to an axis. It is often required to described parts that are at differing radial positions with regard to an axis. In this case, if a first component resides closer to the axis than a second component, it may be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis.

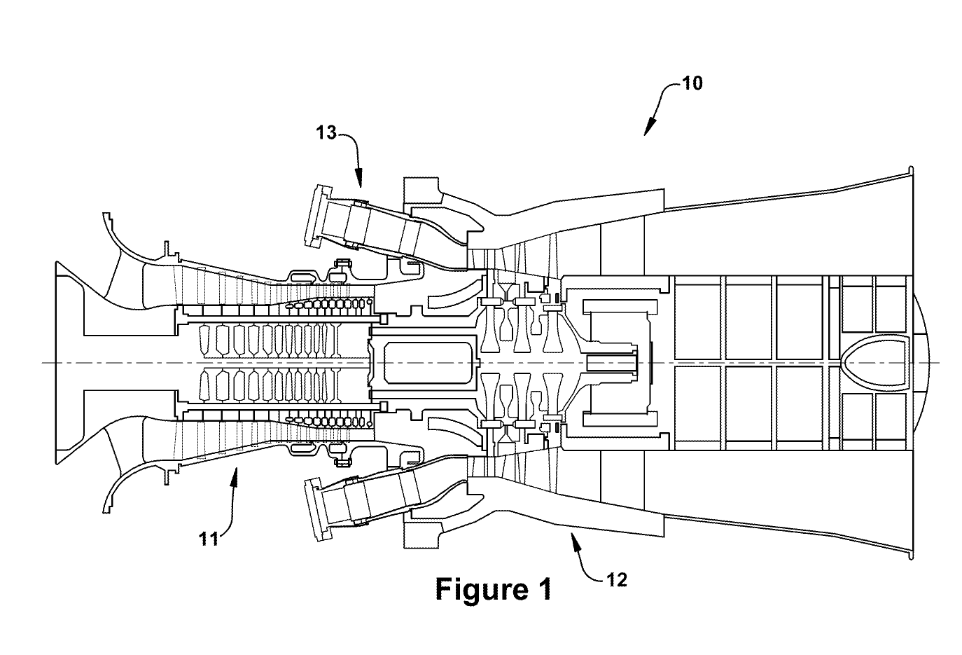

By way of background, referring now to the figures, FIGS. 1 through 3 illustrate an exemplary combustion turbine engine in which embodiments of the present application may be used. It will be understood by those skilled in the art that the present invention is not limited to this type of usage. As stated, the present invention may be used in combustion turbine engines, such as the engines used in power generation and airplanes, steam turbine engines, and other type of rotary engines. FIG. 1 is a schematic representation of a combustion turbine engine 10. In general, combustion turbine engines operate by extracting energy from a pressurized flow of hot gas produced by the combustion of a fuel in a stream of compressed air. As illustrated in FIG. 1, combustion turbine engine 10 may be configured with an axial compressor 11 that is mechanically coupled by a common shaft or rotor to a downstream turbine section or turbine 11, and a combustor 13 positioned between the compressor 11 and the turbine 12.

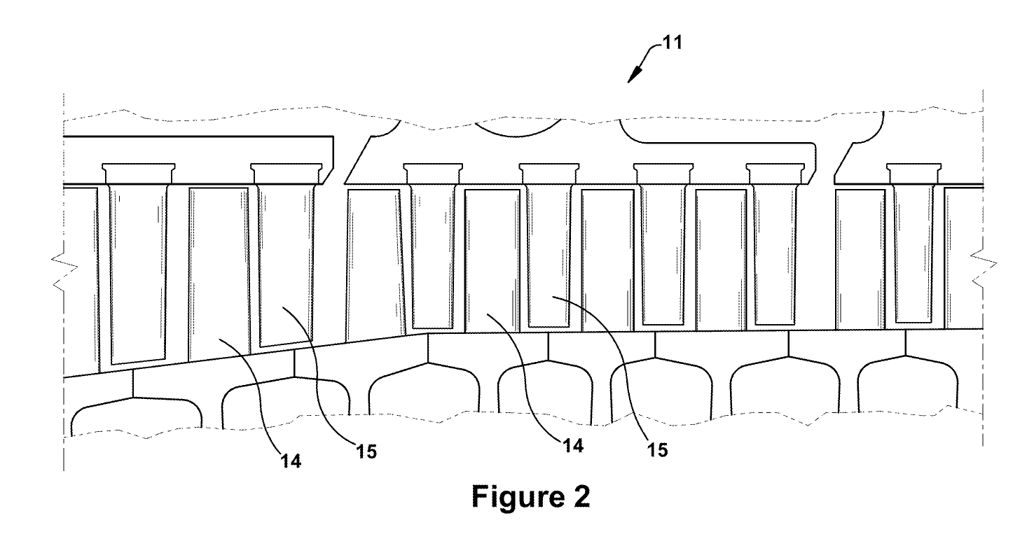

FIG. 2 illustrates a view of an exemplary multi-staged axial compressor 11 that may be used in the combustion turbine engine of FIG. 1. As shown, the compressor 11 may include a plurality of stages. Each stage may include a row of compressor rotor blades 14 followed by a row of compressor stator blades 15. Thus, a first stage may include a row of compressor rotor blades 14, which rotate about a central shaft, followed by a row of compressor stator blades 15, which remain stationary during operation. The compressor stator blades 15 generally are circumferentially spaced one from the other and fixed about the axis of rotation. The compressor rotor blades 14 are circumferentially spaced and attached to the shaft; when the shaft rotates during operation, the compressor rotor blades 14 rotate about it. As one of ordinary skill in the art will appreciate, the compressor rotor blades 14 are configured such that, when spun about the shaft, they impart kinetic energy to the air or fluid flowing through the compressor 11. The compressor 11 may have other stages beyond the stages that are illustrated in FIG. 2. Additional stages may include a plurality of circumferential spaced compressor rotor blades 14 followed by a plurality of circumferentially spaced compressor stator blades 15.

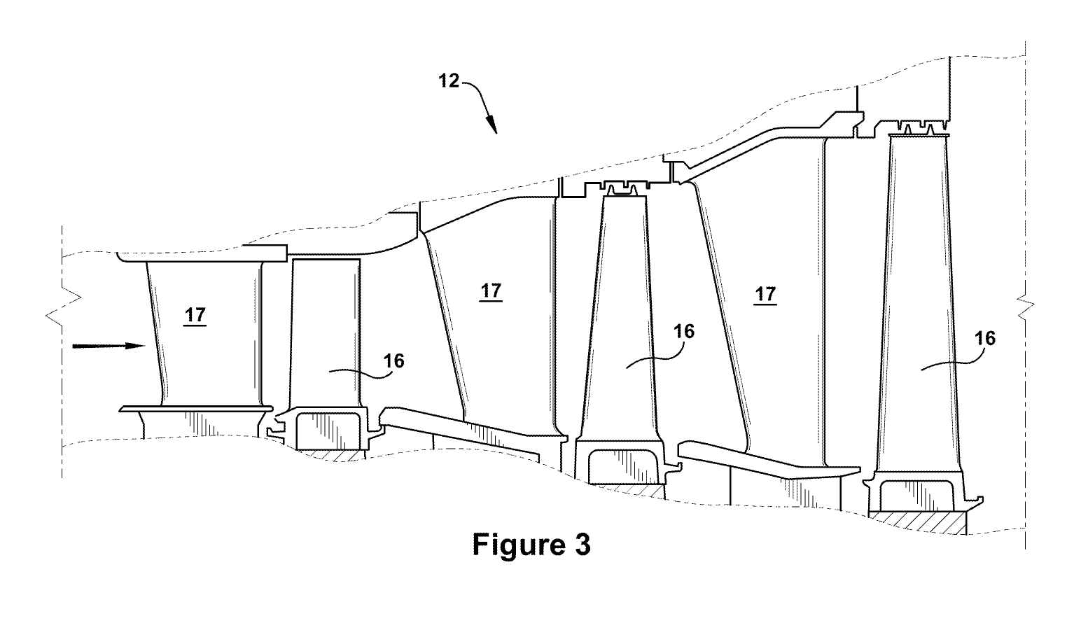

FIG. 3 illustrates a partial view of an exemplary turbine section or turbine 11 that may be used in the combustion turbine engine of FIG. 1. The turbine 11 also may include a plurality of stages. Three exemplary stages are illustrated, but more or less stages may present in the turbine 11. A first stage includes a plurality of turbine buckets or turbine rotor blades 16, which rotate about the shaft during operation, and a plurality of nozzles or turbine stator blades 17, which remain stationary during operation. The turbine stator blades 17 generally are circumferentially spaced one from the other and fixed about the axis of rotation. The turbine rotor blades 16 may be mounted on a turbine wheel (not shown) for rotation about the shaft (not shown). A second stage of the turbine 11 also is illustrated. The second stage similarly includes a plurality of circumferentially spaced turbine stator blades 17 followed by a plurality of circumferentially spaced turbine rotor blades 16, which are also mounted on a turbine wheel for rotation. A third stage also is illustrated, and similarly includes a plurality of turbine stator blades 17 and rotor blades 16. It will be appreciated that the turbine stator blades 17 and turbine rotor blades 16 lie in the hot-gas path of the turbine 11. The direction of flow of the hot gases through the hot-gas path is indicated by the arrow. As one of ordinary skill in the art will appreciate, the turbine 11 may have other stages beyond the stages that are illustrated in FIG. 3. Each additional stage may include a row of turbine stator blades 17 followed by a row of turbine rotor blades 16.

In use, the rotation of compressor rotor blades 14 within the axial compressor 11 may compress a flow of air. In the combustor 13, energy may be released when the compressed air is mixed with a fuel and ignited. The resulting flow of hot gases from the combustor 13, which may be referred to as the working fluid, is then directed over the turbine rotor blades 16, the flow of working fluid inducing the rotation of the turbine rotor blades 16 about the shaft. Thereby, the energy of the flow of working fluid is transformed into the mechanical energy of the rotating blades and, because of the connection between the rotor blades and the shaft, the rotating shaft. The mechanical energy of the shaft may then be used to drive the rotation of the compressor rotor blades 14, such that the necessary supply of compressed air is produced, and also, for example, a generator to produce electricity.

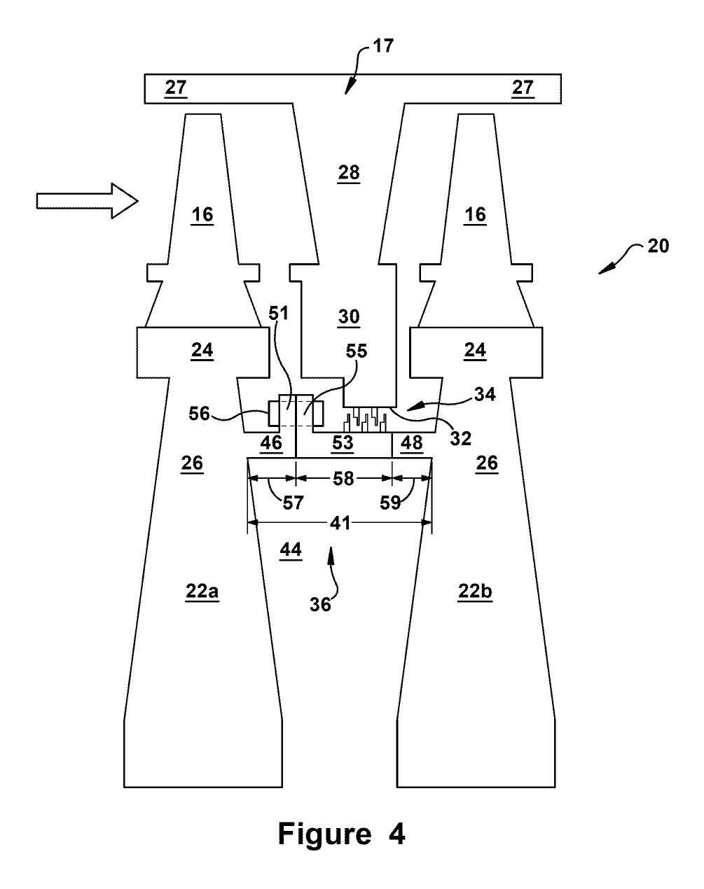

Referring now to FIGS. 4-6, section views are provided of schematic representations of rotor disc attachment assemblies 20 according to embodiments of the present application are provided. As shown, in an exemplary application, a pair of rotor discs 22 is illustrated as the discs 22 might be installed and employed in a turbine section of a combustion turbine engine. As stated, this type of application of the present invention is exemplary only. Other uses, such as uses in the compressor sections of combustion engines, steam turbines or other rotary engines are possible.

The rotor discs 22 may include an outer radial portion 24 that includes attachment means that carry the rotor blades 16. Inboard of the outer radial portion 24, a web portion 26 of the rotor discs 22 extends radially toward the center of the discs 22. Between the two rotor blades 16, a stator blade 17 is positioned. As described, stator blades 17 are stationary components that, typically, are fixed to the inner shell 27 of the turbine. Stator blades 17 generally include an airfoil 28, which is the part that interacts with the flow of working fluid through the engine, and, inboard of the airfoil 28, a diaphragm 30. Diaphragms 30 generally define the inner radial boundary of the flow path for the working fluid between the rotor blades. Note: the direction of flow is indicated by the arrow provided. Also, along an inboard surface 32, diaphragms 30 typically are used to form the stationary component of a seal 34. The seal 34 is positioned as shown, i.e., within the radial gap that is typically present rotating and non-rotating parts, to prevent or limit the amount of working fluid that leaks there through. It will be appreciated that working fluid that bypasses the airfoil 28 through this gap has a negative effect on the efficiency of the turbine engine, which is the reason the seal 34 is provided.

FIG. 4 further illustrates a rotor disc attachment assembly 20 according to an exemplary embodiment of the present application. A sectioned torque arm 36 is shown. It will be appreciated that the torque arm 36 generally spans an attachment distance 41. The length of the attachment distance 41 is defined by, at one end, a predetermined radial location along a web portion of the upstream or first rotor disc 22a and, at the other end, a predetermined radial location along a web portion of the downstream or second rotor disc 22b. The torque arm 36 may be configured per conventional materials to provide structural, torque transmission functions by rigidly connecting the first rotor disc 22a and the second rotor disc 22b between the predetermined radial locations along each web portion. The torque arm 36 also may extend circumferentially to form a cylinder shape that substantially separates areas of the turbine that are exposed to the hot gas path of the engine from a rotor disc cavity 44 formed on an inboard side of the torque arm 36.

The torque arm 36 of the present invention includes three non-integral sections. The first section is a first axial extension 46 that extends from the first rotor disc 22a. The second section is a second axial extension 48 that extends from the second rotor disc 22b. The first and second axial extensions 46, 48 may be part of and integrally formed with the first and second rotor discs 22a, 22b, respectively. Generally, the first axial extension 46 and the second axial extension 48, upon installation within an assembled turbine engine, include extensions that extend primarily in the axial direction from the web portion 26 of the rotor discs 22a, 22b. The axial extensions 46, 48 generally extend toward and point toward each other. In some embodiments, the axial extensions 46, 48 have a substantially constant axial length and extend circumferential around the center axial of the turbine engine at a given radial height.

According to exemplary embodiments of the present application, the length of the first and second axial extensions 46, 48 may be relatively short. This, as described above, maintains reasonable manufacturing costs for the rotor discs. It will be appreciated by those of ordinary skill in the art that, due to conventional forging practices, the cost of manufacturing rotor discs increases dramatically as the length of an axially extending arm, such as the first and second axial extensions 46, 48, increases. At a distal end, as shown, the first axial extension 46 includes a disc flange 51 that extends in an outward radial direction. At a distal end, as shown, the second axial extension 48 includes a surface that allows a weld connection to be formed thereto, which will be referred to herein as a “weld surface”.

The third section of the torque arm 36 is a bridge section, which will be referred to herein as a bridge 53. At one end, the bridge 53 includes a bridge flange 55 that extends in an outward radial direction and is configured to engage and form a mechanical connection with the disc flange 51. At the other end, the bridge 53 includes a weld surface that is configured to form a weld connection with the weld surface of the second axial extension 48. Conventional mechanical connections may be used to removably connect the disc flange 51 to the bridge flange 55. As shown, in one embodiment, a bolted connection using a bolt 56 may be used.

As stated, the first axial extension 46 and the second axial extension 48 may have a relatively short length, with the bridge 53 spanning the remainder of the attachment distance 41. It will be appreciated that the length of the first axial extension 46 (which is referenced as distance 57 in FIG. 4), the length of the second axial extensions 48 (which is referenced as distance 58 in FIG. 4), and the length of the bridge 53 (which is referenced as distance 59 in FIG. 4) according to the present invention may be expressed as a percentage of the overall attachment distance 41. In certain embodiments of the present invention, the first axial extension 46 and the second axial extension 48 each comprises a length that is less than 0.5 of the attachment distance 41. More preferably, the first axial extension 46 and the second axial extension 48 each comprises a length that is less than 0.4 of the attachment distance 41. In still other preferred embodiments, the first axial extension 46 and the second axial extension 48 each comprises a length that is less than 0.3 of the attachment distance 41.

In regard to the lengths of all three sections of the torque arm 36, in some preferred embodiments, the length of the first axial extension 46 comprises a range of 0.15 to 0.35 of the attachment distance 41; the length of the second axial extension 48 comprises a range of 0.15 to 0.35 of the attachment distance 41; and the length of the bridge 53 comprises a range of 0.30 to 0.70 of the attachment distance 41. More preferably, in some embodiments, the length of the first axial extension 46 comprises about 0.25 of the attachment distance 41; the length of the second axial extension 48 comprises about 0.25 of the attachment distance 41; and the length of the bridge 53 comprises about 0.50 of the attachment distance 41.

As stated, a seal 34 may be formed between the inboard surface 32 of the diaphragm 30 and the torque arm 36. The seal 34 may include seal structure positioned on the inboard surface 32 of the diaphragm 30 that interacts with or is configured in relation to seal structure positioned on the outboard surface 60 of the torque arm 36 such that a seal is formed. More particularly, in some embodiments, the seal structure that is positioned on the torque arm 36 is positioned on the outboard surface of the bridge 53. The seal structure on the bridge 53 may include structure that extends radially outward from the surface of the bridge 53 so that the radial gap between the rotating and non-rotating components is narrowed. In some embodiments, several axially thin projections or “teeth” may extend radially from the surface of the bridge 53. These teeth may coincide with teeth positioned on the diaphragm to form interlocking teeth. In this manner, a labyrinth seal may be formed in this location, as shown in FIG. 4. The torturous path formed by the labyrinth seal limits the leakage flow through the radial gap.

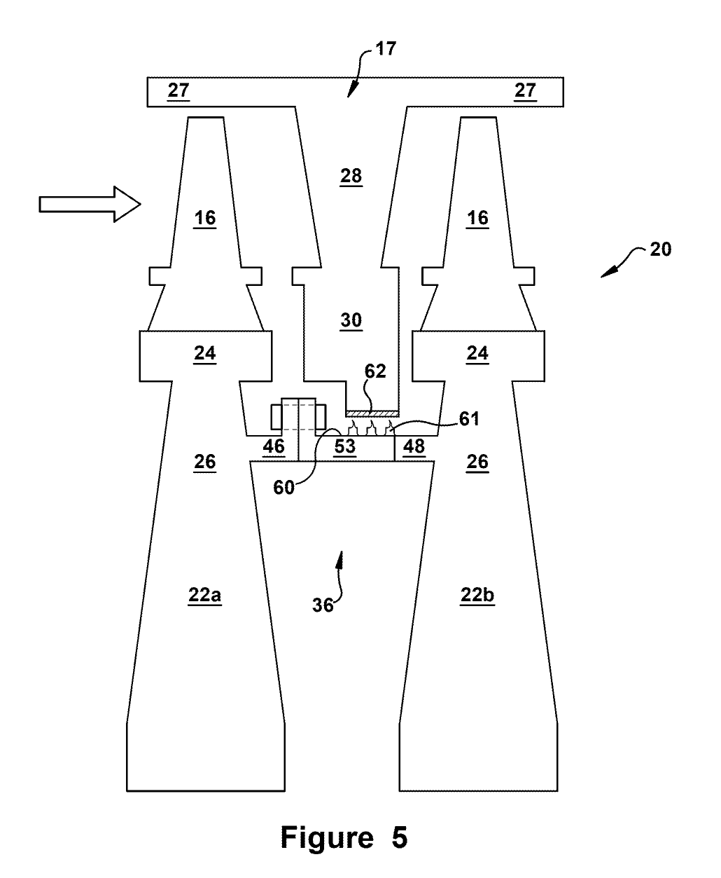

FIG. 5 illustrates an alternative embodiment having a different seal type in the location of the seal 35. As shown, a plurality of cutter teeth 61 may be formed on the outboard surface 60 of the torque arm 36. The cutter teeth 61 generally comprise a radial projection that is configured with a durable, sharp edge. Opposing the cutter tooth 61, an area of abradable material 62 may be positioned along the inboard surface 32 of the diaphragm 30. In operation, due to the thermal growth within the turbine engine, the cutter tooth 61 comes in contact with the abradable material 62 and erodes a channel within it so that an effective seal is created. It will be appreciated that other types of seals are also possible.

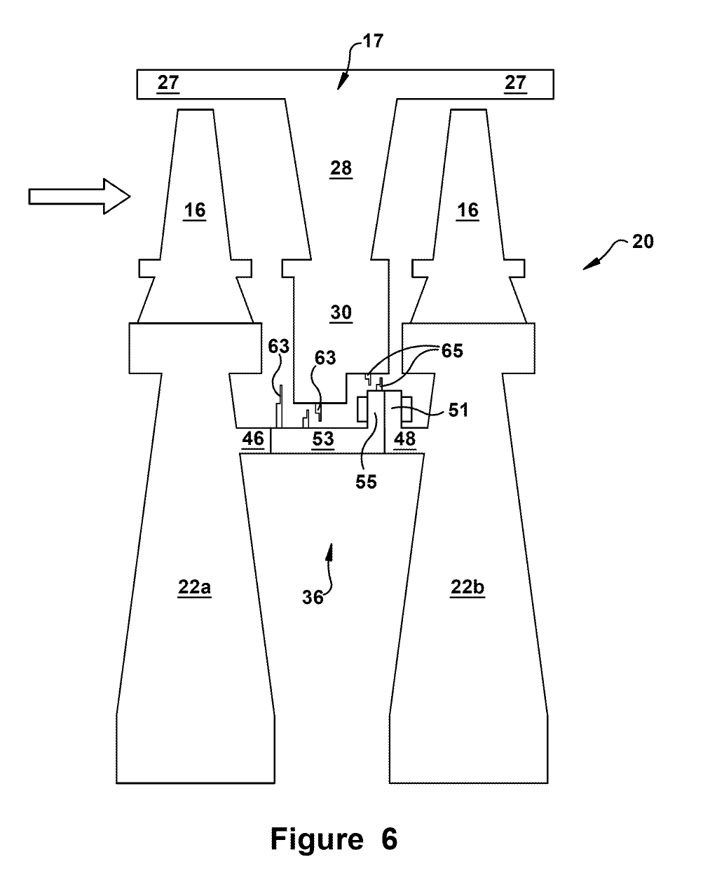

FIG. 6 illustrates an alternative embodiment of the present invention. As shown, instead of being positioned on the first axial extension 46, the disc flange 51 is positioned on the second axial extension 48 of the downstream rotor disc 22b. Accordingly, the removable mechanical connection is made between the downstream side of the bridge 53 (on which the bridge flange 55 is located) and the axial extension 48 on the downstream rotor dust 22b. In this case, the upstream end of the bridge 53 includes a weld surface, which may be welded to the first axial extension 46, as shown. In this arrangement, the radial height of the disc flange 51 and/or the bridge flange 55 may be configured such that it overlaps radially with the radial height of the inner radial boundary of the diaphragm 30. In other words, the radial height of the disc flange 51 resides in an outboard position relative to the inner radial boundary of the diaphragm 30, as is depicted in FIG. 6. This configuration creates a more tortuous leakage path through the radial gap and may be configured to reduce leakage. Having the disc flange 51 and the bridge flange 55 located at the upstream side of the torque arm 36 also may assist in creating a more tortuous path for leakage flow, but, it will be appreciated, that positioning the structure at the downstream side may increase its effectiveness. As shown, other radial teeth 63 may be positioned within the gap and/or upstream of the gap to create more of sealing features. In addition, one or more sealing features may be positioned on the disc flange 51 and/or the bridge flange 55. As shown, this may include a radial projection 65. In other embodiments (not shown), it may include one or more cutter teeth.

The present invention further includes methods of attaching neighboring rotor discs. It will be appreciated that the several components that are described as being part of these methods may be consistent with the description provided above. In one embodiment, the method may include the steps of: a) forming a first rotor disc 22 that includes a first axial extension 46, 48 extending from a web portion 26 of the first rotor disc 22, wherein, at a distal end, the first axial extension 46, 48 comprises a disc flange 51; b) forming a second rotor disc 22 that includes a second axial extension 46, 48 extending from a web portion 26 of the second rotor disc 22, wherein, at a distal end, the second axial extension 46, 48 comprise a weld surface; c) forming a bridge 53, the bridge 53 that includes a bridge flange 55 at one end and a weld surface at the other end, and, along an outer radial surface 60, the bridge 53 comprises means for sealing 34; d) attaching the bridge and 53 to the second rotor disc 22 via welding the weld surface of the bridge 53 to the weld surface of the second axial extension 46, 48; and e) attaching the first rotor disc 22 to the bridge 53 via removably securing the disc flange 51 to the bridge flange 55.

In some embodiments, the step of attaching the bridge 53 to the second rotor disc 22 via welding the weld surface of the bridge 53 to the weld surface of the second axial extension 46, 48 is completed before the step of attaching the first rotor disc 22 to the bridge 53 via removably securing the disc flange 51 to the bridge flange 55 and while at least one of the first rotor disc 22 and the second rotor disc 22 comprises an uninstalled condition. It will be appreciated that this allows access to the underside or inner radial surface of the weld, which provides several advantages. One advantage is that the welding may be performed from both an outer radial position and an inner radial position. Another advantage is that the access allows the machining of the weld from an inner radial position. In many conventional assemblies, this type of access is not available. Having access permits the internal cavities to be machined after the weld connection is formed, which affords the opportunity to remove weld-induced distortion. Also, such access allows the machining of the weld drop and the removal of any metallurgical defects.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A method of attaching two rotor discs in a turbine engine, the method comprising the steps of:
forming a first rotor disc that includes a first axial extension extending from a web portion of the first rotor disc, wherein, at a distal end, the first axial extension comprises a disc flange;
forming a second rotor disc that includes a second axial extension extending from a web portion of the second rotor disc, wherein, at a distal end, the second axial extension comprise a weld surface;
forming a bridge, the bridge that includes a bridge flange at one end and a weld surface at the other end, and, along an outer radial surface, the bridge comprises means for sealing;
attaching the bridge to the second rotor disc via welding the weld surface of the bridge to the weld surface of the second axial extension; and
attaching the first rotor disc to the bridge via removably securing the disc flange to the bridge flange.

2. The method according to claim 1, wherein the first axial extension and the second axial extension, upon installation of the rotor discs within the assembled turbine engine, comprise extensions that extend primarily in the axial direction from the web portion of the discs; and wherein the axial extensions comprise a substantially constant axial length and extend circumferentially around the circumference of the turbine engine.

3. The method according to claim 3, wherein:
the first axial extension extends from a predetermined radial location along the web portion of the first rotor disc;
the second axial extension extends from a predetermined radial location along the web portion of the second rotor disc;
an attachment distance is defined by the distance between the predetermined radial location along the web portion of the first rotor disc and the predetermined radial location along the web portion of the second rotor disc; and
the first axial extension and the second axial extension each comprises a length that is less than half of the attachment distance.

4. The method according to claim 3, wherein the first axial extension and the second axial extension each comprises a length that is less than 0.4 of the attachment distance.

5. The method according to claim 3, wherein the first axial extension and the second axial extension each comprises a length that is less than 0.3 of the attachment distance.

6. The method according to claim 3, wherein the length of the first axial extension comprises a range of 0.15 to 0.35 of the attachment distance; the length of the second axial extension comprises a range of 0.15 to 0.35 of the attachment distance; and the length of the bridge comprises a range of 0.30 to 0.70 of the attachment distance.

7. The method according to claim 3, wherein the length of the first axial extension comprises about 0.25 of the attachment distance; the length of the second axial extension comprises about 0.25 of the attachment distance; and the length of the bridge comprises about 0.50 of the attachment distance.

8. The method according to claim 1, wherein the step of attaching the bridge to the second rotor disc via welding the weld surface of the bridge to the weld surface of the second axial extension is completed before the step of attaching the first rotor disc to the bridge via removably securing the disc flange to the bridge flange and while at least one of the first rotor disc and the second disc comprises an uninstalled condition;
wherein the step of attaching the bridge to the second rotor disc via welding the weld surface of the bridge to the weld surface of the second axial extension includes the steps of:
welding the weld surface of the bridge to the weld surface of the second axial extension from an outer radial position; and
welding the weld surface of the bridge to the weld surface of the second axial extension from an inner radial position.

9. The method according to claim 1, wherein the step of attaching the bridge to the second rotor disc via welding the weld surface of the bridge to the weld surface of the second axial extension is completed before the step of attaching the first rotor disc to the bridge via removably securing the disc flange to the bridge flange and while at least one of the first rotor disc and the second disc comprises an uninstalled condition;
further comprising the step of machining the weld formed between the weld surface of the bridge to the weld surface of the second axial extension from an inner radial position.

10. The method according to claim 1, wherein the first rotor disc and the second rotor discs comprise rotor discs within one of a compressor within the turbine engine or a turbine within a turbine engine; and wherein the first rotor disc comprises an upstream disc and the second rotor disc comprises a downstream disc.

11. The method according to claim 1, wherein the first rotor disc and the second rotor discs comprise rotor discs within one of a compressor within the turbine engine or a turbine within a turbine engine; and wherein the first rotor disc comprises a downstream disc and the second rotor disc comprises an upstream disc.

12. The method according to claim 11, wherein
the disc flange is configured to extend in an outboard direction from an outer radial surface of the first axial extension, and comprises a radial height;
the bridge flange extends in an outboard direction from an outer radial surface of the bridge, and comprises a radial height;
wherein the radial height of at least one of the disc flange and the bridge flange comprises a radial height that, upon installation within the assembled turbine engine, results in at least one of the disc flange and the bridge flange overlapping radially with an inboard radial boundary of the stationary structure that surrounds the bridge from an outboard position.

13. The method according to claim 1, wherein:
upon installation within the assembled turbine engine, the bridge, the first axial extension, and the second axial extension form a cylinder shape that substantially separates the hot gas path of the turbine engine from a rotor disc cavity formed on an inboard side of the cylinder;
the means for sealing comprises one of a radial projection and a cutter tooth; and
the means for sealing is positioned on the bridge flange.

14. The method according to claim 1, wherein the means for sealing, upon installation within the assembled turbine engine, comprises structure that narrows the radial gap between the outer radial surface of the bridge and the stationary structure that surrounds the bridge from an outboard position; and
wherein the means for sealing comprises radial projection that, upon installation within the assembled turbine engine, is configured to form a high-low labyrinth seal with at least one radial projection positioned on the stationary structure that surrounds the bridge from the outboard position.

15. The method according to claim 1, wherein the means for sealing, upon installation within the assembled turbine engine, comprises structure that narrows the radial gap between the outer radial surface of the bridge and the stationary structure that surrounds the bridge from an outboard position; and
wherein the means for sealing comprises one or more cutter teeth that, upon installation within the assembled turbine engine and operation of the turbine engine, are configured to cut into an abradable material positioned on the stationary structure that surrounds the bridge from the outboard position.

16. A method of attaching two rotor discs in a turbine engine, the method comprising the steps of:
forming a first rotor disc that includes a first axial extension extending from a web portion of the first rotor disc, wherein, at a distal end, the first axial extension comprises a disc flange;
forming a second rotor disc that includes a second axial extension extending from a web portion of the second rotor disc, wherein, at a distal end, the second axial extension comprise a weld surface;
forming a bridge, the bridge that includes a bridge flange at one end and a weld surface at the other end, and, along an outer radial surface, the bridge comprises means for sealing;
attaching the bridge to the second rotor disc via welding the weld surface of the bridge to the weld surface of the second axial extension;
while at least one of the first rotor disc and the second disc comprises an uninstalled condition, machining an underside of the weld formed between the weld surface of the bridge to the weld surface of the second axial extension from an inner radial position; and
after machining the weld formed between the weld surface of the bridge and the weld surface of the second axial extension; attaching the first rotor disc to the bridge via removably securing the disc flange to the bridge flange.

17. The method according to claim 16, wherein:
the first axial extension extends from a predetermined radial location along the web portion of the first rotor disc;
the second axial extension extends from a predetermined radial location along the web portion of the second rotor disc;
an attachment distance is defined by the distance between the predetermined radial location along the web portion of the first rotor disc and the predetermined radial location along the web portion of the second rotor disc; and
the first axial extension and the second axial extension each comprises a length that is less than 0.4 of the attachment distance.

18. The method according to claim 17, wherein the length of the first axial extension comprises a range of 0.15 to 0.35 of the attachment distance; the length of the second axial extension comprises a range of 0.15 to 0.35 of the attachment distance; and the length of the bridge comprises a range of 0.30 to 0.70 of the attachment distance.

19. An assembly of rotor discs in a turbine engine, the assembly comprising:
a first rotor disc and a second rotor disc that are spaced and positioned to rotate about a common axis; and
a torque arm that comprises an attachment distance defined by a predetermined radial location along a web portion of the first rotor disc and a predetermined radial location along a web portion of the second rotor disc; the torque arm structurally connecting the first rotor disc and the second rotor disc between the predetermined radial locations along each web portion and arm extending circumferentially to form a cylinder shape that substantially separates the hot gas path of the turbine engine from a rotor disc cavity formed on an inboard side of the torque arm;
wherein:
the torque arm comprises three connected structural sections: i) a first axial extension that extends from the first rotor disc, is integrally formed therewith, and, at a distal end, comprises a disc flange; ii) a second axial extension that extends from the second rotor disc, is integrally formed therewith, and, at a distal end, comprises a weld surface; and iii) a bridge that, at one end, includes a bridge flange configured to form a mechanical connection with the disc flange and, at the other end, a weld surface configured to form a weld connection with the weld surface of the second axial extension;
securing means removably join the disc flange to the bridge flange;
along an outboard surface, the torque arm comprises means for forming a seal between the torque arm and stationary structure that, upon installation within the assembled turbine engine, surrounds the torque arm from an outboard position; and
the first axial extension and the second axial extension each comprises a length that is less than 0.4 of the attachment distance.

20. The assembly of rotor discs according to claim 19, wherein the length of the first axial extension comprises a range of 0.15 to 0.35 of the attachment distance; the length of the second axial extension comprises a range of 0.15 to 0.35 of the attachment distance; and the length of the bridge comprises a range of 0.30 to 0.70 of the attachment distance.

21. The assembly of rotor discs according to claim 20, wherein the first rotor disc comprises a downstream disc and the second rotor disc comprises an upstream disc; and wherein:
the disc flange is configured to extend in an outboard direction from an outer radial surface of the first axial extension, and comprises a radial height;
the bridge flange extends in an outboard direction from an outer radial surface of the bridge, and comprises a radial height;
wherein the radial height of at least one of the disc flange and the bridge flange comprises a radial height that, upon installation within the assembled turbine engine, results in at least one of the disc flange and the bridge flange overlapping radially with an inboard radial boundary of the stationary structure that surrounds the bridge from an outboard position.
